(19) United States
(12) Patent Application Publication
(10) Pub. No.: US 2016/0196512 A1
(43) Pub. Date: Jul. 7, 2016

(54) SCIENTIFIC WORKFLOW DISTRIBUTION PLATFORM

(71) Applicant: Biodatomics, LLC, Bethesda, MD (US)

(72) Inventor: Maxim Mikheev, Elkridge, MD (US)

(21) Appl. No.: 15/070,571

(22) Filed: Mar. 15, 2016

Related U.S. Application Data
(63) Continuation of application No. 14/099,864, filed on Dec. 6, 2013, now abandoned.

(51) Int. Cl. G06Q 10/06

(52) U.S. Cl. CPC G06Q 10/0633

(57) ABSTRACT

Provided are methods and systems for scientific workflow distribution. A digital scientific workflow distribution platform comprises a user interface configured to allow a user to select a scientific workflow based on one or more parameters associated with the scientific workflow. Based on the selection, a distribution module enables acquiring the scientific workflow and importing the scientific workflow into a user environment. The digital scientific workflow distribution platform further comprises a management engine for scientific workflows configured to support development of the scientific workflow imported into the user environment.

### TECHNICAL FIELD

This disclosure relates generally to data processing and, more specifically, to a scientific workflow distribution platform.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A traditional workflow management system manages and defines a series of tasks within a project to produce a final result. Workflow management systems allow defining different workflows for different types of tasks or processes. Furthermore, workflow management systems assist users in development of complex applications at a higher level by orchestrating functional components without handling the implementation details. At each stage in the workflow, one or more executable software modules may be responsible for a specific task. Once the task is complete, the workflow software ensures that the next task is executed by the modules responsible for the next stage of the process. The workflow management system reflects the dependencies required for the completion of each task. In general, a workflow management system controls automated processes by automating redundant tasks and ensuring that uncompleted tasks are followed up on.

The workflow management system can be developed in a specialized form for specific needs. Specifically, a scientific workflow management system can be designed to compose and execute a series of computational and data processing operations for a scientific application. An example of a scientific workflow management system is a bioinformatics workflow management system that focuses on a specific domain of science. Bioinformatics can be defined as an interdisciplinary field that develops and improves on methods for storing, retrieving, organizing and analyzing biological data. A major activity in bioinformatics is to develop software tools to generate useful biological knowledge. Since scientific workflows differ from traditional business process workflows, the scientific workflow management system enables scientists to perform specific steps. For example, interactive tools can be provided enabling scientists to execute scientific workflows and to view results in real-time. Additionally, scientists are able to track the source of the workflow execution results and the steps used to create the workflow.

A workflow with a default set of tools can be purchased from a developer of the workflow. However, adding tools developed by other developers or modifying the default tools may not be possible because of the compatibility and other issues. Furthermore, available workflows are restricted to specific types of applications and their adaptation for scientific purposes can be difficult.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for scientific workflow distribution. Specifically, a digital scientific workflow distribution platform comprises a user interface configured to allow a user to select a scientific workflow based on one or more parameters associated with the scientific workflow. Based on the selection, a distribution module enables the user to acquire the scientific workflow and import the scientific workflow into a user environment. The digital scientific workflow distribution platform further comprises a management engine for scientific workflow configured to support development of the scientific workflow and workflow tools imported into the user environment. While prior art may include scientific workflow distributions, it does not include subsequently modifiable workflows.

According to another approach of the present disclosure, there is provided a computer-implemented method for scientific workflow distribution. According to the method, a user interface receives a user command to select a scientific workflow based on one or more parameters associated with the scientific workflow. In response to the user command, the user is enabled to acquire the scientific workflow and to import the scientific workflow into a user environment. After the import of the scientific workflow, development of the scientific workflow can be supported by a management engine for scientific workflows.

In further example embodiments of the present disclosure, the method steps are stored on a machine-readable medium comprising instructions, which when implemented by one or more processors perform the recited steps. In yet further example embodiments, hardware systems, or devices can be adapted to perform the recited steps. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 shows an environment within which a digital scientific workflow distribution platform and corresponding methods can be implemented, according to an example embodiment.

FIG. 2 is a block diagram showing various modules of a digital scientific workflow distribution platform, according to an example embodiment.

FIG. 3 is a scheme illustrating a method for scientific workflow distribution, according to an example embodiment.

FIG. 4 is a scheme illustrating a method for workflow tool distribution, according to an example embodiment.

FIG. 5 is a process flow diagram showing a computer-implemented method for scientific workflow distribution, according to an example embodiment.

FIG. 6 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive, or a computer-readable medium. It should be noted that methods disclosed herein can be implemented by a mobile terminal, a smart phone, a computer (e.g., a desktop computer, a tablet computer, a laptop computer), and so forth.

The present disclosure relates to systems and methods for scientific workflow distribution. Specifically, embodiments described herein include a digital scientific workflow distribution platform and a computer-implemented method for scientific workflow distribution. The digital scientific workflow distribution platform described herein provides a virtual marketplace for scientific workflows. The platform can be configured to distribute scientific workflows for scientific data analysis as well as to support various workflow tools. The digital scientific workflow distribution platform enables scientists in the fields of science such as, for example, biology, bionomics, and bioinformatics, to query and analyze sequence data using a number of informatics tools and save the results.

In some example embodiments, a user can access the digital scientific workflow distribution platform via a user interface and review available scientific workflows. Upon selection of a scientific workflow, the user can send a request for acquisition of the scientific workflow to the digital scientific workflow distribution platform. The digital scientific workflow distribution platform can provide the scientific workflow to the user as software as a service (SaaS). The scientific workflow is hosted in a cloud environment.

Upon receiving the user request, the digital scientific workflow distribution platform can import the selected scientific workflow into the user environment. The user is provided with access to the user environment (for example, by registering with the platform). Upon authentication, the user is provided with access to the scientific workflow and is able to perform various workflow operations. For example, the scientific workflow can be used to manage computations of biological data.

The digital scientific workflow distribution platform can allow users to develop the scientific workflow imported into the user environment. In particular, the user is able to select and change parameters of the scientific workflow, add, remove, and modify tools associated with the scientific workflow, select conditions and order of execution, and so forth. An operator of the digital scientific workflow distribution platform can be responsible for maintenance and support of the scientific workflow development environment.

After importing the scientific workflow into the user environment, the user may desire to acquire or develop additional workflow tools. The digital scientific workflow distribution platform allows for development and operational supports of workflow tools. The platform can facilitate development of the tools using an Application Programming Interface (API) associated with the platform. The platform can also allow distribution of the tools to users as well as running the tools in a cloud computing environment. For example, a user can access the digital scientific workflow distribution platform and select tools to be added to the scientific workflow. The digital scientific workflow distribution platform receives the user request and adds the selected tool to the scientific workflow. After the tools are added, the user can utilize the tool in the scientific workflow.

As mentioned above, the digital scientific workflow distribution platform allows users to develop tools imported into the user environment. In particular, the user is able to add, create, or modify the tools of the scientific workflow (e.g., by editing tool parameters).

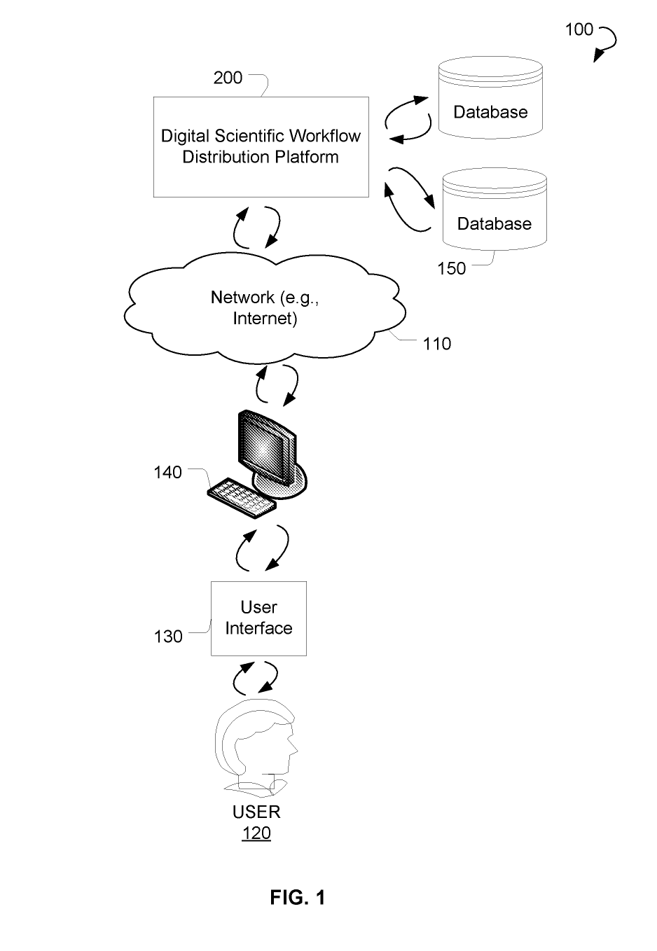

Referring now to the drawings, FIG. 1 illustrates an environment 100 within which a digital scientific workflow distribution platform and a method for scientific workflow distribution can be implemented. The environment 100 includes a network 110, a user 120, a digital scientific workflow distribution platform 200, a user interface 130, one or more user devices 140, and a database 150.

The network 110 includes the Internet or any other network capable of communicating data between devices. Suitable networks include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 includes a network of data processing nodes that are interconnected for the purpose of data communication. Generally, the network 110 includes a number of similar or dissimilar devices connected together by a transport medium enabling communication between the devices by using a predefined protocol. Those skilled in the art will recognize that the present disclosure may be practiced within a variety of network configuration environments and on a variety of computing devices.

The user device 140, in some example embodiments, includes a Graphical User Interface (GUI) for displaying the user interface 130. In a typical GUI, instead of offering only text menus or requiring typed commands, the platform 200 presents graphical icons, visual indicators, or special graphical elements called widgets. The user interface 130 is utilized as a visual front-end to allow the user 120 to build and modify complex tasks with little or no programming expertise.

The user device 140 includes a mobile telephone, a computer, a lap top, a smart phone, a phablet, tablet PC, and so forth. In some embodiments, the user device 140 is associated with one or more users 120. The user device 140 is configured to utilize icons used in conjunction with text, labels, or text navigation to fully represent the information and actions available to the user 120. The user 120, in some example embodiments, is a person interacting with the user interface 130 via one of the user devices 140. The user 120 may include a person that uses the platform 200 for his or her needs. For example, the user 120 includes a scientist intending to use a scientific workflow provided by the platform 200 for performing a series of computational or data manipulation steps. The platform 200 can be connected to one or more databases 150. The databases 150 can store data associated with the scientific workflows, the user 120, and other data needed for development of the scientific workflow.

As shown on FIG. 1, the user 120 can access the platform 200 via the user interface 130 presented on the user device 140. The user 120 can send a request to the platform 200 via the user interface 130. In an example embodiment, the request can be provided by selection of the scientific workflow to be acquired. In response to the request of the user 120, the platform 200 imports the selected scientific workflow into a user environment.

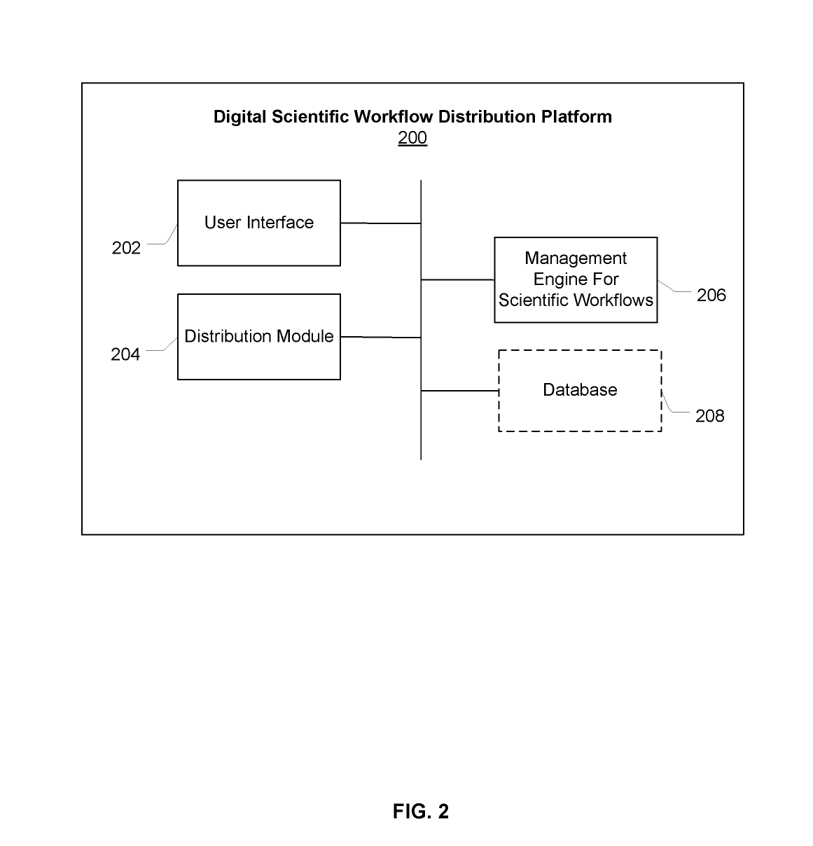

FIG. 2 shows a detailed block diagram of the digital scientific workflow distribution platform 200, in accordance with an example embodiment. The platform 200 can include a user interface 202, a distribution module 204, a management engine 206 for scientific workflows, and, optionally, a database 208.

The user can utilize the user interface 202 to access the platform 200. The user interface 202 can allow the user to select one of the scientific workflows from the scientific workflows available on the platform 200. The user can make the selection based on one or more parameters associated with the scientific workflow. Specifically, after accessing the platform 200, the user can view one or more of the following parameters: a list of available scientific workflows, specific information associated with each of the scientific workflows, tools available for each of the scientific workflows, price of the scientific workflows, and so forth.

In an example embodiment, the user can select the scientific workflow of interest by clicking on the workflow pictogram.

In an example embodiment, the user interface 202 can be configured to provide one or more of the following functionalities: searching for the scientific workflow, viewing information associated with the scientific workflow, purchasing the scientific workflow, importing the scientific workflow into a user environment, enabling a developer to develop a tool and upload the tool to the management engine for scientific workflows, and so forth.

The user interface 202 can be regulated by a platform operator. In an example embodiment, each scientific workflow requires an approval process and compliance with predetermined guidelines. The approval process and checking compliance of the scientific workflow with predetermined guidelines can be performed by the platform operator.

The distribution module 204 of the platform 200 can be configured to enable the user to acquire the scientific workflow. Furthermore, the distribution module 204 can be operable to enable importing the scientific workflow into a user environment. For example, the scientific workflow can be implemented as application installed on a user device or as a web-based application.

In an example embodiment, the distribution module 204 can allow assessing fees from a workflow user. For example, a user account associated with the platform 200 can be charged for the scientific workflow to be imported into the user environment. Thus, for example, before the scientific workflow is imported into the user environment, an amount corresponding to the price of the scientific workflow can be subtracted from the user account and transferred to an account associated with the workflow owner. Moreover, a percentage of the fees or a flat amount can be paid to the platform operator. The scientific workflow can be sold on a subscription basis, for example by paying a monthly fee or an annual fee. In another example embodiment, the scientific can sold on a per use basis, for a one-time lump sum, and so forth.

The scientific workflow is available as SaaS so that the scientific workflow and associated data are centrally hosted in a cloud environment. In such environment, a user can access the scientific workflow via a web browser using a thin client. When the scientific workflow is provided as a SaaS, its use can be easily tracked and the user charged per use.

In a multi-tenant SaaS environment, the cost of user provisioning (i.e., creation, maintenance and deactivation of user attributes) is relatively low. Thus, the workflow provider may even offer the user a free workflow service with limited functionality or scope. In this case, the fees can be charged only for enhanced functionality in addition to the basic free workflow service.

The management engine 206 for scientific workflows of the platform 200 can be configured to support development of the scientific workflow imported into the user environment. The management engine 206 for scientific workflows can comprise a decision node, a fork-join queuing cluster, and a distributed database. The management engine 206 for scientific workflows can be communicatively coupled to an application running in the user environment and enable the user to manage and define a series of tasks within the application. Various events can occur as the applications runs. These events can include user actions, sensor outputs, notification from other programs, and so forth. Each event can be associated with one or more conditions that are stored in the management engine 206 for scientific workflows.

In an example embodiment, the decision node is configured to determine that at least one condition is true. The determination that the at least one condition is true can be performed by running a conditional loop. The conditional loop can be configured to check whether the at least one condition is true. The decision node can be further configured to selectively activate, based on the determination, the at least one computational module. The computational module can include a computational tool. The scientific workflow can support a plurality of biological data formats as well as translations between the plurality of biological data formats. A computational tool can pertain to a specific field of science (for example, bioinformatics). In this case, the computational tool is a bioinformatics tool enabling the user to process specific bioinformatics tasks.

After activation of the computational module, the fork-join queuing cluster can allocate at least one computational module non-sequentially to participant computational nodes. The participant computational nodes can be located in a distributed cloud computing environment. Using the participant computational nodes, the fork-join queuing cluster can process a data set according to predetermined criteria.

The distributed database 208 can be configured to store at least one computational module and at least one condition associated with the at least one computational module. Furthermore, the distributed database 208 can be configured to store data associated with the scientific workflows, the user, and other data needed for development of the scientific workflow by the user. Once the scientific workflow is imported into the user environment, the user can be able to edit the scientific workflow. Furthermore, the user can edit parameters and tools associated with the scientific workflow.

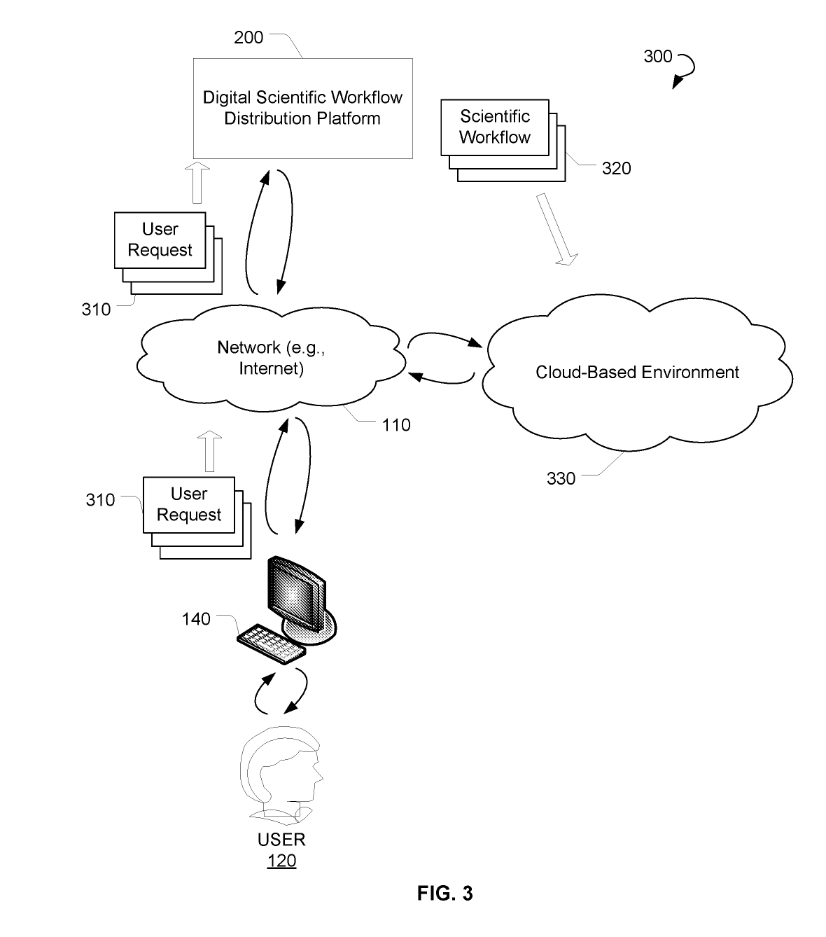

FIG. 3 illustrates a method for scientific workflow distribution 300, according to another example embodiment. The user 120 can use a user device 140 having a user interface to connect to the digital scientific workflow distribution platform 200. The user device 140 can be connected with the digital scientific workflow distribution platform 200 via the network 110. Upon connecting to the digital scientific workflow distribution platform 200, the user 120 can search for scientific workflows that can be acquired from the digital scientific workflow distribution platform 200. The user 120 can view information associated with the available scientific workflows. The user 120 can select a scientific workflow and send a user request 310 to the digital scientific workflow distribution platform 200.

In an example embodiment, the user request 310 can be related to acquiring the scientific workflow and importing the scientific workflow into the user environment. Upon receiving the user request 310, the digital scientific workflow distribution platform 200 processes the user request 310. After processing the user request 310, the digital scientific workflow distribution platform 200 can provide the scientific workflow 320 to the cloud-based environment 330 of the user 120. In the embodiment shown on FIG. 3, the scientific workflow 320 is a web-based scientific workflow and is configured to be imported into the cloud-based environment 330. The user 120 can access the cloud-based environment 330 via the user interface on the user device 140.

Providing the scientific workflow 320 to the user 120 can include importing scientific workflow 320 into the cloud-based environment 330. After import of the scientific workflow 320, the user 120 may edit the scientific workflow 320 according to his or her needs.

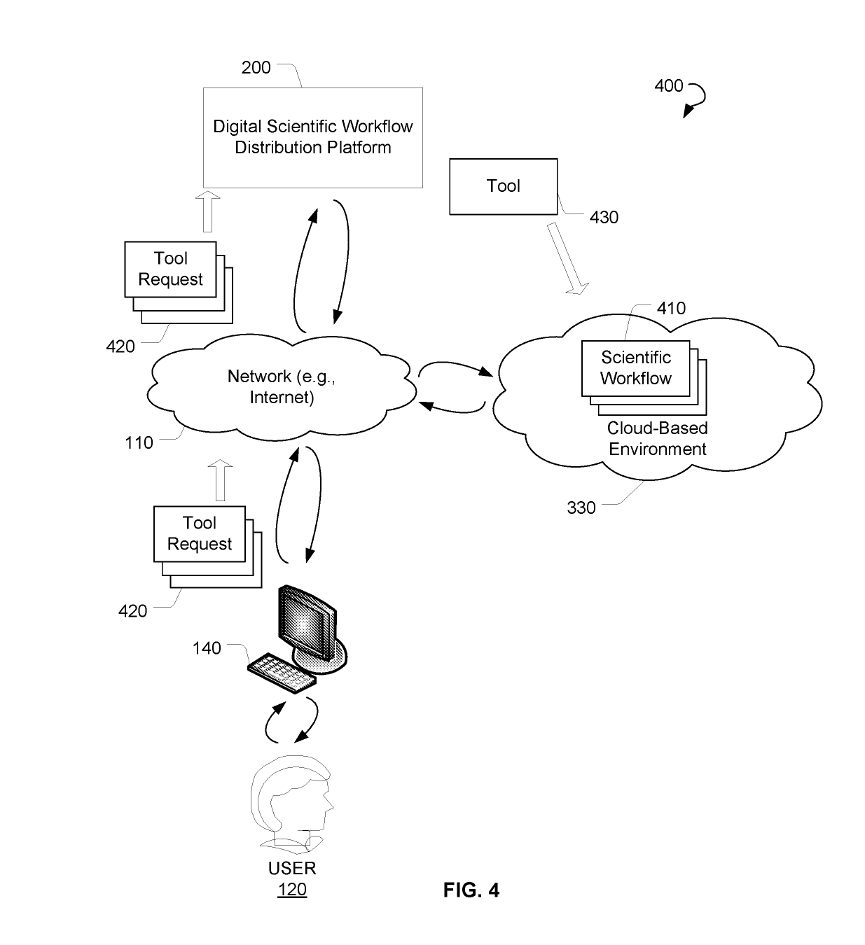

FIG. 4 illustrates a method for workflow tool distribution 400, according to an example embodiment. After import of the scientific workflow into the cloud-based environment shown on FIG. 3, the user 120 can develop the scientific workflow 410 by acquiring tools associated with the scientific workflow 410. The user 120 can utilize a user device 140 having a user interface to connect to the digital scientific workflow distribution platform 200 via the network 110. Upon connecting to the digital scientific workflow distribution platform 200, the user 120 can search for tools available for acquisition in the digital scientific workflow distribution platform 200. The tools are then associated with the scientific workflow 410 installed in the cloud-based environment 330 (i.e., the tools can be added into the scientific workflow 410). The user 120 views information associated with the available tools and selects the tools of interest. The user 120 can send a tool request 420 to the digital scientific workflow distribution platform 200. In an example embodiment, the tool request 410 includes acquiring the tool to be added into the user environment 330. Upon receiving the tool request 420, the digital scientific workflow distribution platform 200 can process the tool request 420. After processing the tool request 420, the digital scientific workflow distribution platform 200 can add the tool 430 to the scientific workflow 410 in the cloud-based environment 330. After adding the tool 430, the user 120 is able to edit the tool 430 associated with the scientific workflow 410.

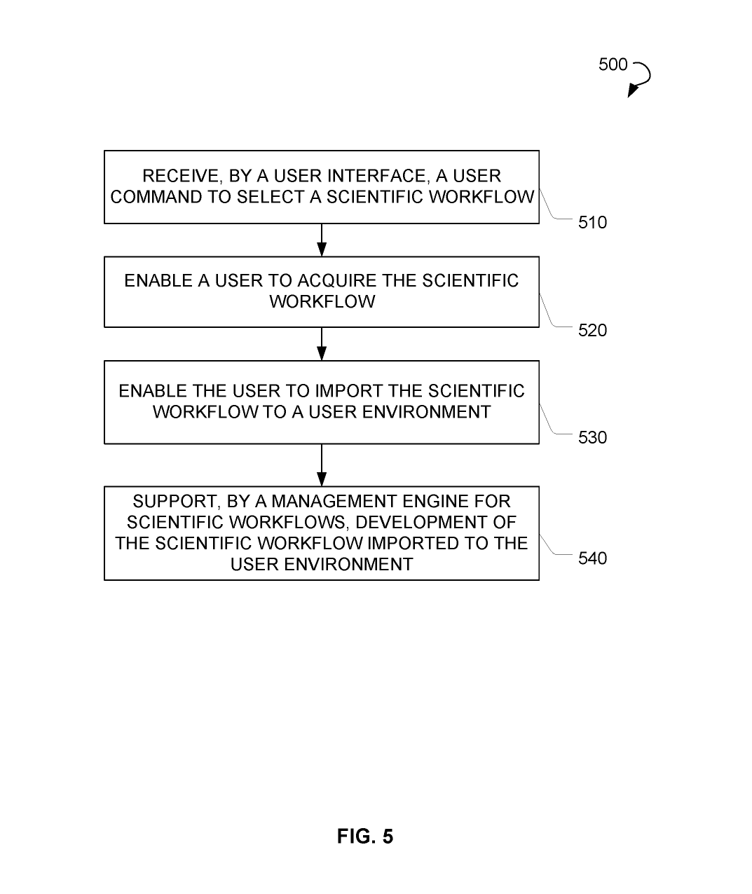

FIG. 5 is a process flow diagram showing a computer-implemented method 500 for scientific workflow distribution, according to an example embodiment. The method 500 can be performed by processing logic that comprises hardware (e.g., decision making logic, dedicated logic, programmable logic, and microcode), software (such as software running on a general-purpose computer system or a dedicated machine), or a combination of both.

The method 500 can commence with receiving, by a user interface, a user command to select a scientific workflow at operation 510. The user can make a selection based on one or more parameters associated with the scientific workflow. At operation 520, the user is able to acquire the scientific workflow. At operation 530, the user is able to import the scientific workflow into a user environment. In an example embodiment, the scientific workflow can include an application installed on a user device, such as client software accessing the platform or a web-based scientific workflow. The scientific workflow can be sold on a subscription basis, a per use basis, a one-time lump sum basis, a peer-to-peer basis, or the like. In an example embodiment, the scientific workflow is distributed as SaaS.

After import of the scientific workflow, a management engine for scientific workflows supports development of the scientific workflow imported into the user environment at operation 540. In order to support the development of the scientific workflow, the management engine for scientific workflows can include a decision node, a fork-join queuing cluster, and a distributed database. The decision node is configured to determine that at least one condition associated with an event occurring in the scientific workflow is true. The determination that the at least one condition is true is performed by running a conditional loop configured to check whether the at least one condition is true.

Furthermore, based on the determination, the decision node can selectively activate at least one computational module. The computational module can processes a task associated with the true condition. The fork-join queuing cluster can be configured to allocate the at least one computational module non-sequentially to participant computational nodes in a distributed cloud computing environment. The fork-join queuing cluster can process a data set according to predetermined criteria. The distributed database can be configured to store the computational module and the condition associated with the computational module. The computation module is not activated until the at least one condition is true. Development of the scientific workflow includes modifying the scientific workflow and modifying parameters and tools associated with the scientific workflow after the scientific workflow is imported into the user environment.

In an example embodiment, the user interface is configured to provide one or more of the following functionalities: searching for the scientific workflow, viewing information associated with the scientific workflow, purchasing the scientific workflow, importing the scientific workflow into a user environment, enabling a developer to develop a tool and upload the tool to the management engine for scientific workflows, and so forth. The user interface can be regulated by a platform operator. Each scientific workflow may require an approval process and compliance with predetermined guidelines. The platform operator can perform the approval process and control compliance of the scientific workflow with the predetermined guidelines.

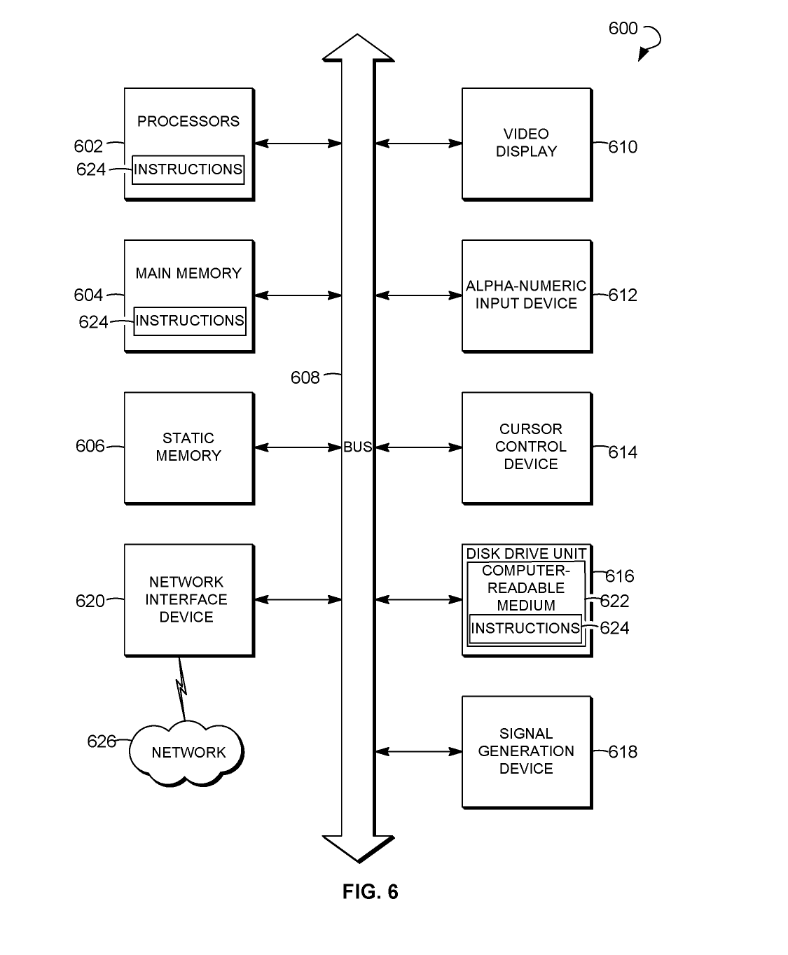

FIG. 6 shows a diagrammatic representation of a machine in the example electronic form of a computer system 600, within which a set of instructions for causing the machine to perform any one or more of the methodologies discussed herein may be executed. In various example embodiments, the machine operates as a standalone device or are connected (e.g., networked) to other machines. In a networked deployment, the machine operates in the capacity of a server or a client machine in a server-client network environment, or as a peer machine in a peer-to-peer (or distributed) network environment. The machine is a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), a main memory 604 and a static memory 606, which communicate with each other via a bus 608. The computer system 600 further includes a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker), and a network interface device 620.

The disk drive unit 616 includes a non-transitory computer-readable medium 622, on which is stored one or more sets of instructions and data structures (e.g., instructions 624) embodying or utilized by any one or more of the methodologies or functions described herein. The instructions 624 also reside, completely or at least partially, within the main memory 604 and/or within the processors 602 during execution thereof by the computer system 600. The main memory 604 and the processors 602 also constitute machine-readable media.

The instructions 624 are further transmitted or received over a network 626 via the network interface device 620 utilizing any one of a number of well-known transfer protocols (e.g., Hyper Text Transfer Protocol (HTTP)).

While the computer-readable medium 622 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for scientific workflow distribution are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A digital scientific workflow distribution platform comprising:
a user interface configured to allow a user to select a scientific workflow based on one or more parameters associated with the scientific workflow;
a distribution module configured to enable:
a user to acquire the scientific workflow; and
importing the scientific workflow into a user environment; and
a management engine for scientific workflows configured to support development of the scientific workflow imported into the user environment.

2. The platform of claim 1, wherein the user interface is configured to provide one or more of the following functionalities: searching for the scientific workflow, viewing information associated with the scientific workflow, purchasing the scientific workflow, downloading the scientific workflow to a user device, and enabling a developer to develop a tool and upload the tool to the management engine for scientific workflows.

3. The platform of claim 1, wherein the scientific workflow is provided via an application installed on a user device or via a web-based application.

4. The platform of claim 1, wherein the user interface is regulated by a platform operator, each scientific workflow requiring an approval process and compliance with predetermined guidelines.

5. The platform of claim 1, wherein parameters and tools associated with the scientific workflow are editable after the scientific workflow is imported into the user environment.

6. The platform of claim 1, wherein the scientific workflow is editable after being imported into the user environment.

7. The platform of claim 1, wherein the distribution module allows assessing fees from a workflow acquirer.

8. The platform of claim 7, wherein a percentage of the fees is paid to a platform operator.

9. The platform of claim 1, wherein the scientific workflow is sold on a basis selected from one or more of the following: a unlimited usage for a defined period of time, a per-use basis, and a one-time lump sum basis for unlimited use.

10. The platform of claim 1, wherein the scientific workflow is distributed as software as a service (SaaS).

11. A computer-implemented method for scientific workflow distribution comprising:
receiving, by a user interface, a user command to select a scientific workflow based on one or more parameters associated with the scientific workflow;
enabling a user to acquire the scientific workflow;
enabling the user to import the scientific workflow into a user environment; and
supporting, by a management engine for scientific workflows, development of the scientific workflow imported into the user environment.

12. The method of claim 11, wherein the user interface is configured to provide one or more of the following functionalities: searching for the scientific workflow, viewing information associated with the scientific workflow, purchasing the scientific workflow, downloading the scientific workflow to a user device, and enabling a developer to develop a tool and upload the tool to the management engine for scientific workflows.

13. The method of claim 11, wherein the scientific workflow is provided via an application installed on a user device or via a web-based application.

14. The method of claim 11, wherein the user interface is regulated by a platform operator, each scientific workflow requiring an approval process and compliance with predetermined guidelines.

15. The method of claim 11, wherein parameters and tools associated with the scientific workflow are editable after the scientific workflow is imported to the user environment.

16. The method of claim 11, wherein the scientific workflow is sold on a basis selected from one or more of the following: unlimited usage for a defined period of time, a per-use basis, and a one-time lump sum basis for unlimited use.

17. The method of claim 11, wherein the scientific workflow is distributed as software as a service (SaaS).

18. A non-transitory computer-readable medium comprising
instructions, which when executed by one or more processors, perform the following operations:
receive, by a user interface, a user command to select a scientific workflow based on one or more parameters associated with the scientific workflow;
enable a user to acquire the scientific workflow,
enable the user to import the scientific workflow into a user environment; and
support, by a management engine for scientific workflows, development of the scientific workflow imported into the user environment.
